(19) United States
(12) Patent Application Publication
(10) Pub. No.: US 2003/0195947 A1
(43) Pub. Date: Oct. 16, 2003

(54) HTTP server and recording medium recoding HTTP server program

(75) Inventor: Yoshifumi Tanimoto, Hirakata-shi (JP)

Correspondence Address: HOGAN & HARTSON L.L.P., 500 S. GRAND AVENUE, SUITE 1900, LOS ANGELES, CA, 90071-2611, US

(73) Assignee: MURATA KIKAI KABUSHIKI KAISHA

(21) Appl. No.: 10/410,117

(22) Filed: Apr. 9, 2003

(30) Foreign Application Priority Data
Apr. 15, 2002 (JP) 2002-112584

(51) Int. Cl. G06F 15/16

(52) U.S. Cl. 709/219

(57) ABSTRACT

A Hyper Text Transfer Protocol (HTTP) server includes a storage device that store processing status identification information which identifies a condition for changing a status for content by assigning a corresponding file name to each content and a transmitter that transmits the file name of the content stored in the storage device and processing status identification information in accordance with a request from a HTTP client.

### FIELD OF THE INVENTION

The present invention relates to a Hypertext Transfer Protocol (HTTP) server.

### DESCRIPTION OF THE RELATED ART

A HTTP server assigns Uniform Resource Locators (URL) to a storage unit or the like, and stores in the storage unit or the like, a Hypertext Markup Language (HTML) file and content formed from image data. By designating the URL and transmitting the HTML file requested from a HTTP client in accordance with a communication based on the HTTP protocol, character information and the content formed from image data are displayed on a browser of the HTTP client. Further, the details of the HTTP protocol are shown in Request for Comments (RFC) 1945 of the Internet Engineering Task Force (IETF) or the like. The details of the HTML document are shown in RFC 1866 of the IETF or the like.

There are cases when the transmission and reception of the HTML file and the image data carried out between the HTTP server and a client are used for exchanging an original document that is to be transmitted by a facsimile between the HTTP clients. That is, first, one of the HTTP clients uploads the image data of the original document to be transmitted and the HTML file and downloads the image data to the HTTP server. Then, the other HTTP client designates the URL indicating the HTML file, and downloads the uploaded HTML file and the image data of the original document. Accordingly, the original document can be transmitted from one of the HTTP clients to the other HTTP client.

Moreover, in a facsimile server or the like that includes the HTTP server, the content that can be downloaded for the HTTP client is stored in the storage unit by uploading the content and also by a different method. That is, the facsimile server that includes the HTTP server can store the image data of the original document received by G3, G4 facsimiles or Internet facsimile (T.37, T.38) in the storage unit as the content.

However, it was difficult to efficiently manage a processing condition, such as whether or not the content of the original document or the like stored in the HTTP server has been referenced by a specific HTTP client as described above.

### SUMMARY OF THE INVENTION

An HTTP server of the present invention includes a storage unit which stores processing status identification information that identifies whether a condition for changing a status for each content is “processed” or “not processed”, by associating the processing status identification information to a file name of each content. The HTTP server also includes a transmission unit which transmits the file name of the content stored in the storage unit and the processing status identification information in response to a request from the HTTP client.

A fact of whether the prescribed processing is “processed” or “not processed” can be easily grasped for each content from the processing status identification information transmitted by being associated with the file name of the content. As a result, a user can easily manage the processing status of the uploaded content or the like.

In addition, the condition for changing the status of the content is a reference to the content by the HTTP client.

A fact of whether or not each uploaded content or the like has been referenced can be easily managed.

Moreover, the condition for changing the status of the content is a reference to the content and a specific input for the content by the HTTP client.

For each uploaded content or the like to be processed, it becomes necessary to reference and to carry out a specific input of the content. When only referenced, the content is not processed. It is useful for when it is necessary for a person who referenced the content to display a target content, and to communicate that the content has been confirmed to a person who uploaded or the like. For example, when a user of the HTTP client displays the non-target content by mistake, or when the target content is displayed but the details of the content can not be confirmed completely due to the system being busy, no notification is made to the person who uploaded or the like. Therefore, the fact of whether or not the content has been confirmed is prevented from being a problem between the users.

Furthermore, the HTTP server includes a setting unit which sets a condition for changing the status of the content. When the condition for changing the status of the content is set by the setting unit, the content can be referenced.

When the condition for changing the status of the content is not set, the content cannot be referenced from the HTTP client. Therefore, a case in which referencing and other processing are not managed accurately by the content being referenced before the condition is set can be prevented from occurring.

In addition, the HTTP server includes a setting unit which sets a condition for changing the status of the content. When the condition for changing the status of the content is set by the setting unit, a link is applied to the file name for downloading the content and then transmitted.

A link for obtaining the content is set at the HTTP client side in the file name that is displayed through the browser. Therefore, the content can be obtained more easily.

Furthermore, the HTTP server includes a changing unit which changes the processing status identification information from “not processed” to “processed”. The HTTP server also includes a notification unit which notifies that the processing status identification information has been changed to “processed”.

Since a notification of the fact of “processed” is made, a person who uploaded an original document to the HTTP server can receive the notification. Therefore, it becomes unnecessary for the person to request the processing status identification information of the content to the HTTP server to confirm whether or not the content has been processed.

### BRIEF DESCRIPTION OF THE DRAWINGS

FIG. 1 is a view showing an example of a network environment where the HTTP server of an embodiment of the present invention is provided.

FIG. 2 is a view showing an example of a configuration of the HTTP server of an embodiment of the present invention.

FIG. 3 is a flowchart showing an operation of the HTTP server of when the content is uploaded to the HTTP server.

FIG. 4 is view for describing a formation of a table.

FIG. 5 is view for describing a content managing screen and a condition setting screen.

FIG. 6 is a flowchart showing an operation of the HTTP server of when a set button of the content managing screen is selected.

FIG. 7 is a flowchart showing an operation of the HTTP server of when the content is requested from the client PC.

FIG. 8 is view for describing the content managing screen and an original display screen.

### DETAILED DESCRIPTION OF THE PREFERRED EMBODIMENTS

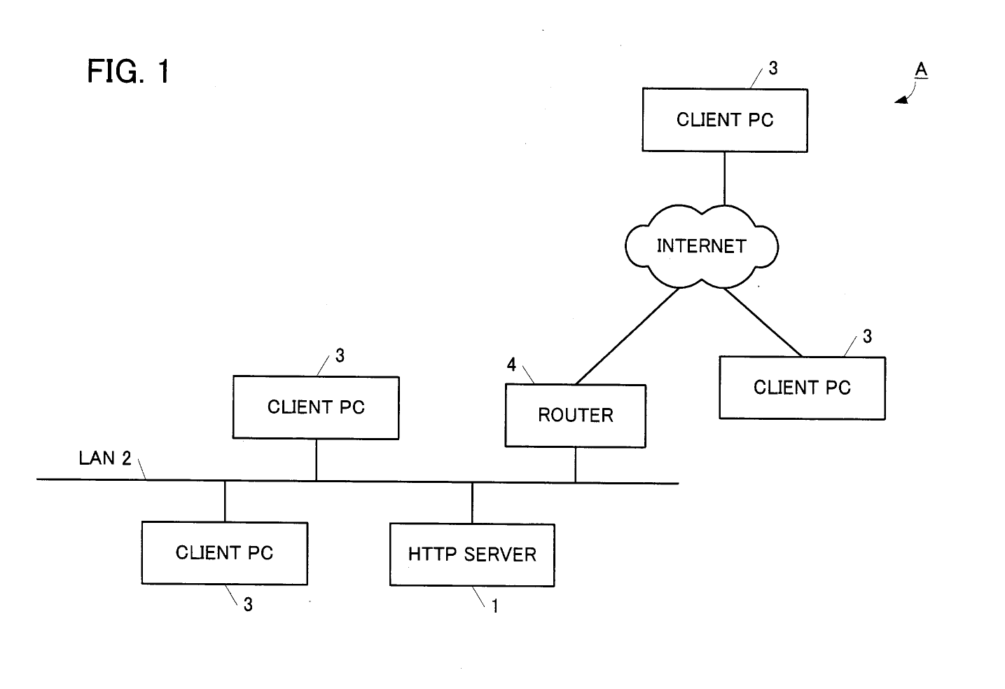

A Hyper Text Transfer Protocol (HTTP) server according to an embodiment of the present invention will be described with reference to the accompanying drawings. FIG. 1 shows an example of a network environment A where the HTTP server 1 is provided. The HTTP server 1 is connected to a Local Area Network (LAN) 2. The HTTP server 1 can communicate with a plurality of client personal computers (client PCs) 3 that are also connected to the LAN 2 in accordance with the HTTP. Moreover, the HTTP server 1 can communicate with a router 4 that is provided on the LAN 2, and also with other client PCs 3 through the Internet in accordance with the HTTP protocol.

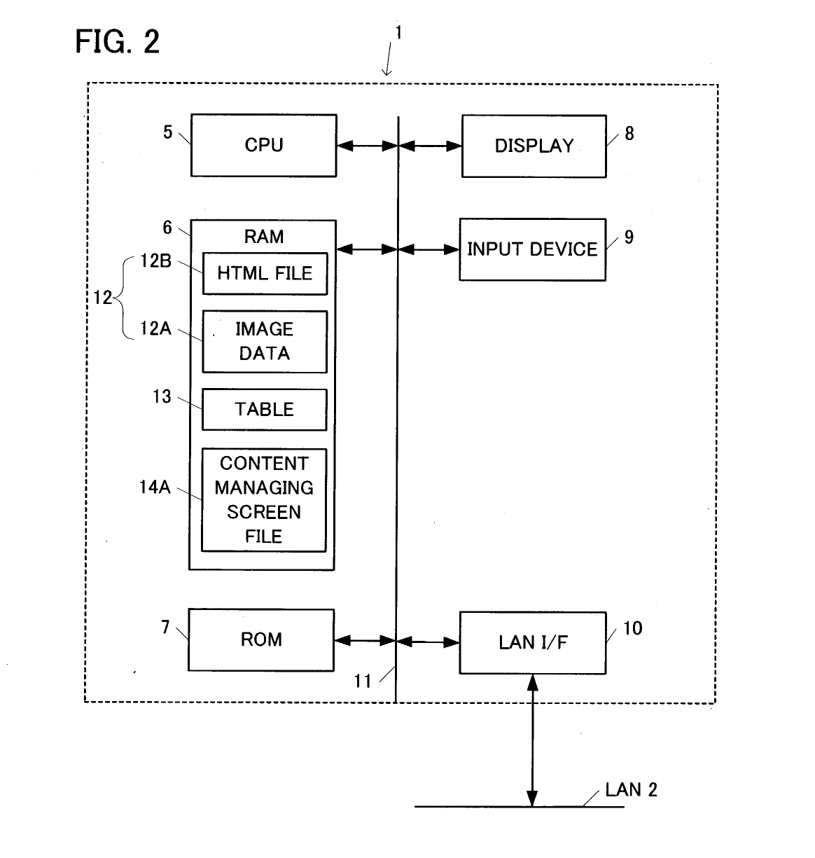

As shown in FIG. 2, for example, the HTTP server 1 includes a Central Processing Unit (CPU) 5, a Random Access Memory (RAM) 6, a Read Only Memory (ROM) 7, a display 8, an input device 9, a LAN interface 10, and a bus 11. The CPU 5 controls each part of the HTTP server 1 in accordance with a prescribed program. The RAM 6 stores content 12, a table 13 or the like that are to be described later on. The ROM 7 stores a HTTP control program that is necessary for the HTTP server 1 to communicate by the HTTP protocol, a control program for executing an operation shown in the flowchart to be described later on. The display 8 displays and provides various information to an operator or the like. The input device 9 includes a mouse, a keyboard, or the like. The LAN interface 10 connects the LAN 2 and the HTTP server 1 such that the communication can be carried out. The bus 11 connects each of the parts 5 through 10 such that the communication can be carried out.

Moreover, the HTTP server 1 includes a function as the HTTP server, and an electronic mail communication function. For carrying out a prescribed notification to be described later on, the HTTP server 1 generates an electronic mail describing a prescribed document, and transmits the electronic mail to a prescribed client PC.

The client PC 3 includes a browser which displays a file in the HTML format on a personal computer or the like. The client PC 3 is a terminal device which functions as the HTTP client.

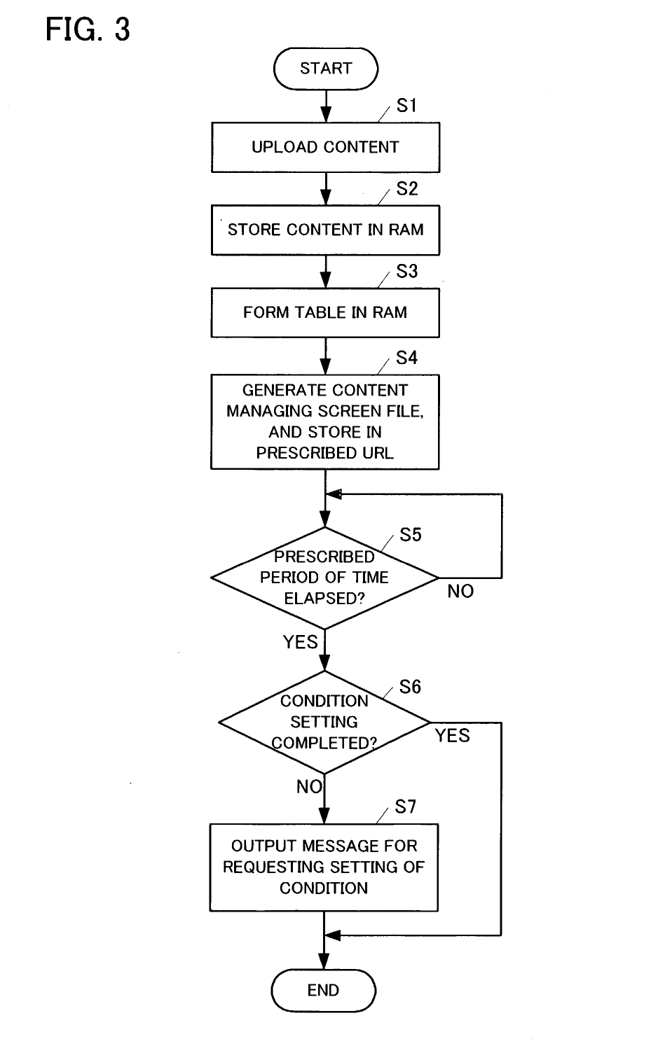

Next, an operation executed by the HTTP server 1 when content 12 is uploaded to the HTTP server 1 from the client PC 3 will be described with reference to the flowchart shown in FIG. 3. Further, the operation of the HTTP server 1 to be described with reference to FIG. 3 is carried out in accordance with a command generated by the CPU 5 based on the control program stored in the ROM 7. Moreover, for example, an operation for selecting and designating by an operator or the like on the screen which is to be described later on is executed by a pointer (not shown in the drawings) or the like displayed on a display of the client PC 3 being located at a prescribed position.

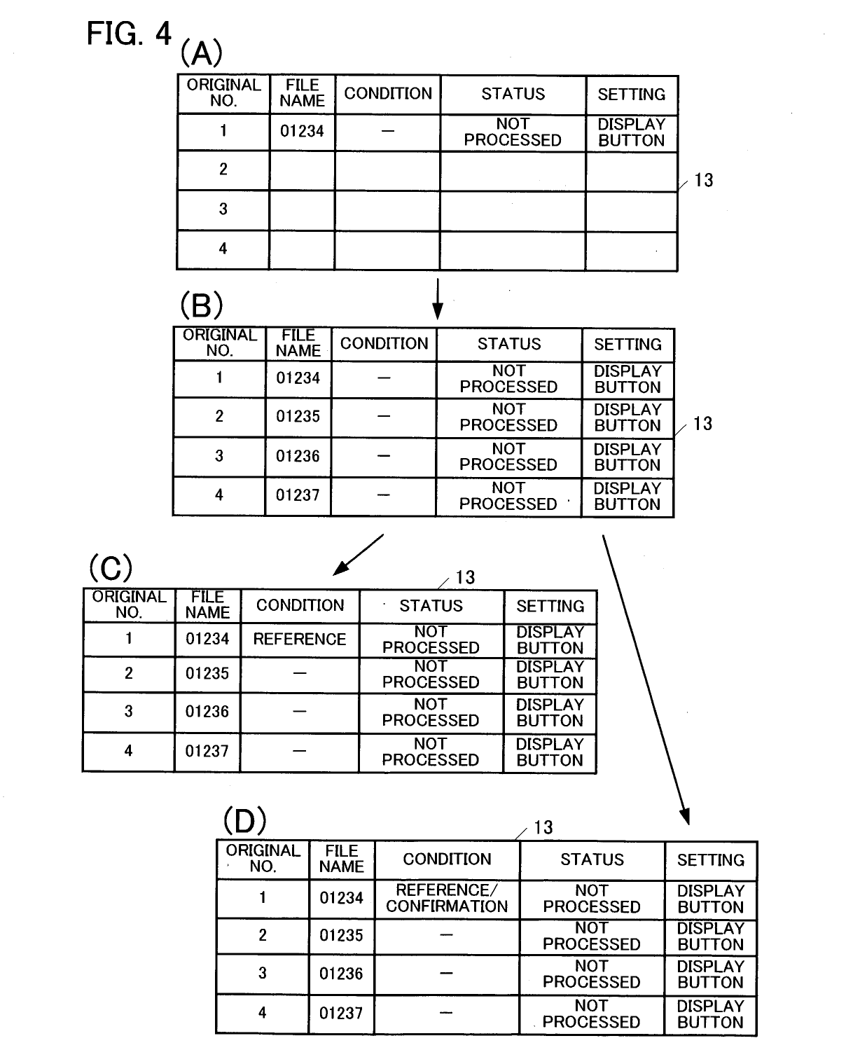

Content 12 such as image data 12A or HTML file 12B is uploaded by the HTTP server 1 from the client PC 3 (S1). The HTTP server 1 stores content 12 in a prescribed area in the RAM 6 (S2). Then, the HTTP server 1 forms a table 13 as shown in FIG. 4 in the RAM 6 (S3).

As shown in FIG. 4(A), table 13 includes “original NO.” column, “file name” column, “condition” column, “status” column, and “setting” column. The “original NO.” column stores a record number. The “file name” column stores a file name of the stored content 12. The “condition” column stores a condition for changing the status of the content to be described later on. The “status” column stores “processed” or “not processed” as information for identifying whether a prescribed processing to be described later on is processed or not processed (hereinafter referred to as “processing status identification information”). The “setting” column stores “display button” or “not display button” as information for designating whether or not to display a set button to be described later on. When the information stored in each column is provided for the same record, the information is associated with one another and stored. Then, each time new image data is uploaded, a record is added. For example, when four contents are uploaded, table 13 as shown in FIG. 4(B) is formed.

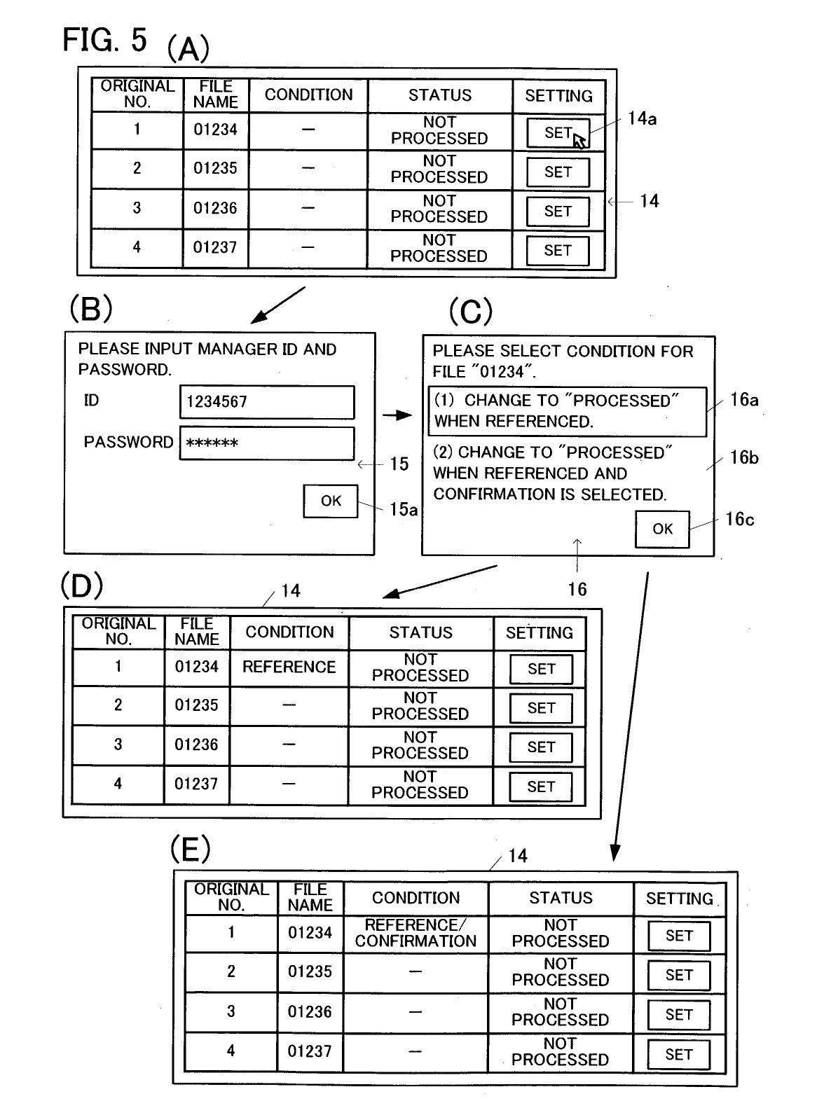

Furthermore, the HTTP server 1 generates a content managing screen file 14A for displaying on a browser of the client PC 3, the content managing screen 14 as shown in FIG. 5(A) that displays the details of table 13. Then, the HTTP server 1 stores the generated content managing screen file 14A in a prescribed URL (S4). The content managing screen 14 displays a heading area of table 13. The content managing screen 14 also displays information that is stored in each column excluding the “setting” column in table 13. Moreover, when “display button” is stored in the “setting” column of table 13, a set button 14a that is to be described later on is displayed in the “setting” column. The set button 14a is provided as a link to the setting screen for setting the condition for changing the status of the content.

When the content managing screen file 14A is stored in S4, and a condition for changing the status of the content to be described later on is not set after an elapse of a prescribed period of time (when the “status” column in table 13 has not changed from “not processed” to “processed”) (S5, S6), a message for requesting the setting of the condition for changing the status of the content is output to the client PC 3 that uploaded the file (S7). The output operation is carried out to the client PC 3 by generating an electronic mail which includes a message for requesting the setting, such as “Please set condition for changing the status of the content”. The output operation is not limited to this example in particular, and other forms of output operations can be carried out. For example, when the client PC 3 requests the content managing screen 14 from the HTTP server 1 for a next time, screen information to display a message such as “Please set condition for changing the status of the content” can be transmitted.

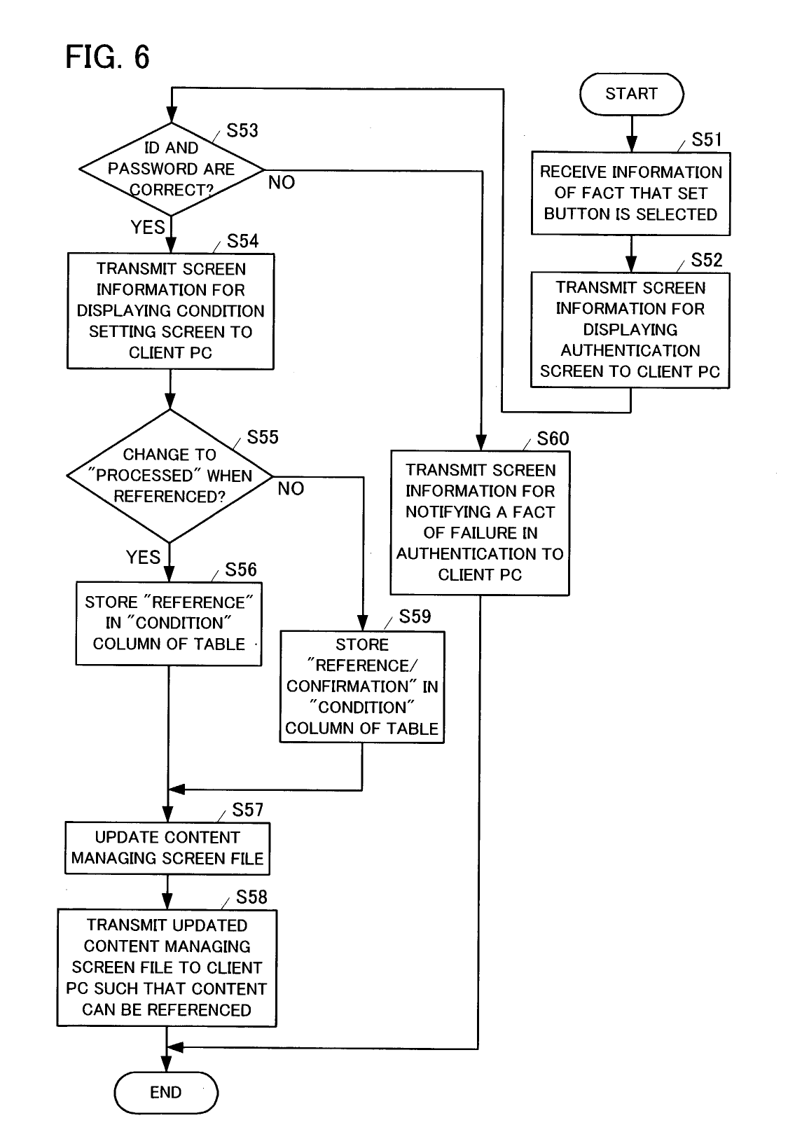

Next, an operation to be executed by the HTTP server 1 when the set button 14a is selected by the operator or the like on the content managing screen 14, will be described with reference to the flowchart shown in FIG. 6. Further, the operation of the HTTP server 1 to be described with reference to FIG. 6 is also carried out in accordance with a command generated by the CPU 5 based on the control program stored in the ROM 7.

When any one of the set button 14a is selected on the content managing screen 14 by an operation of the operator or the like, the HTTP server 1 receives the information indicating such a fact from the client PC 3 (S51). The HTTP server 1 transmits to the client PC 3, screen information for displaying an authentication screen 15 as shown in FIG. 5(B) which demands an input of an Identification (ID) and a password of the operator or the like (S52). Then, the authentication screen 15 is displayed on the client PC 3.

When the ID and the password are input from the authentication screen 15 and the “OK” button 15a is selected at the client PC 3, the HTTP server 1 carries out an authentication of whether or not the input ID and password are correct (S53). When the ID and the password are correct, screen information for displaying a condition setting screen 16 as shown in FIG. 5(C) is transmitted to the client PC 3 (S54). Then, screen 16 is displayed on the client PC 3.

The condition setting screen 16 demands of the operator or the like to set the condition for changing “not processed” to “processed” in the processing status identification information for the file (content) corresponding to the set button 14a selected in S51. The setting is carried out by the operator or the like selecting a selecting item 16a or 16b displayed on the condition setting screen 16. When the setting item 16a (in the drawing, “(1) Change to “processed” when referenced”) is selected, a reference of the file (content) by the client PC 3 is set as the condition for changing “not processed” to “processed”. When the other setting item 16b (in the drawing, “(2) Change to “processed” when referenced and confirmation is selected”) is selected, a reference of the file (content) by the client PC 3, and a specific input to be described later on are set as the condition for changing “not processed” to “processed”.

When the condition setting screen 16 is displayed on the browser of the client PC 3, the selecting item 16a displayed as “(1) Change to “processed” when referenced” is selected, and the “OK” button 16c provided at the lowest position is selected (S55: YES), the HTTP server 1 stores “reference” in the “condition” column of table 13 as shown in FIG. 4(C) (S56). Then, the content managing screen file 14A corresponds to the updated table 13, and a link is provided for downloading the file (content) (S57). The content managing screen file 14A is transmitted to the client PC 3 (S58). Then, the updated content managing screen 14 as shown in FIG. 5(D) is displayed, and it becomes possible to reference the file (content).

Moreover, when the setting item 16b displayed as “(2) Change to “processed” when referenced and confirmation is selected” in the condition setting screen 16 (FIG. 5(C)) is selected, and the “OK” button 16c is selected (S55: NO), the HTTP server 1 stores “reference/confirmation” in the “condition” column of table 13 as shown in FIG. 4(D) (S59). Then, in the same manner as in S57, S58, the content managing screen file 14A is corresponds to the updated table 13, and a link is set for downloading the file. The content managing screen file 14A is transmitted to the client PC 3. The updated content managing screen 14 as shown in FIG. 5(E) is displayed, and it becomes possible to reference the file (content).

Further, when the correct ID and password are not input in S53, screen information notifying a failure in the authentication (for example, screen information for displaying a message such as “password is incorrect”) is transmitted to the client PC 3 (S60).

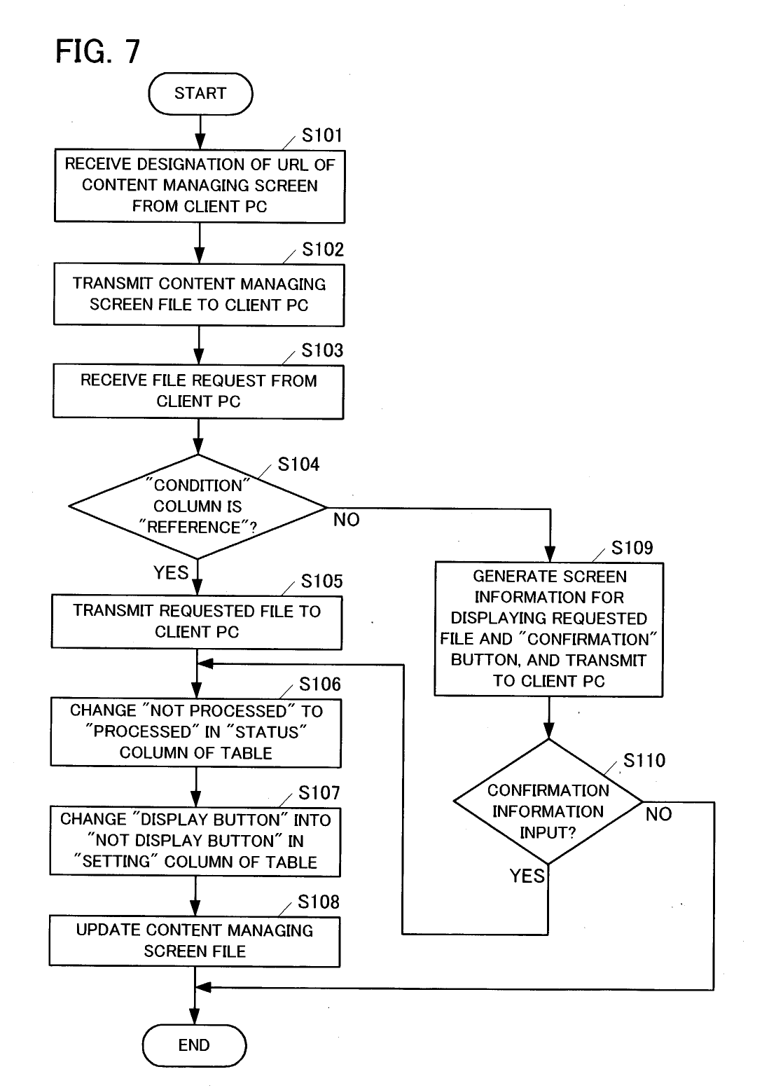

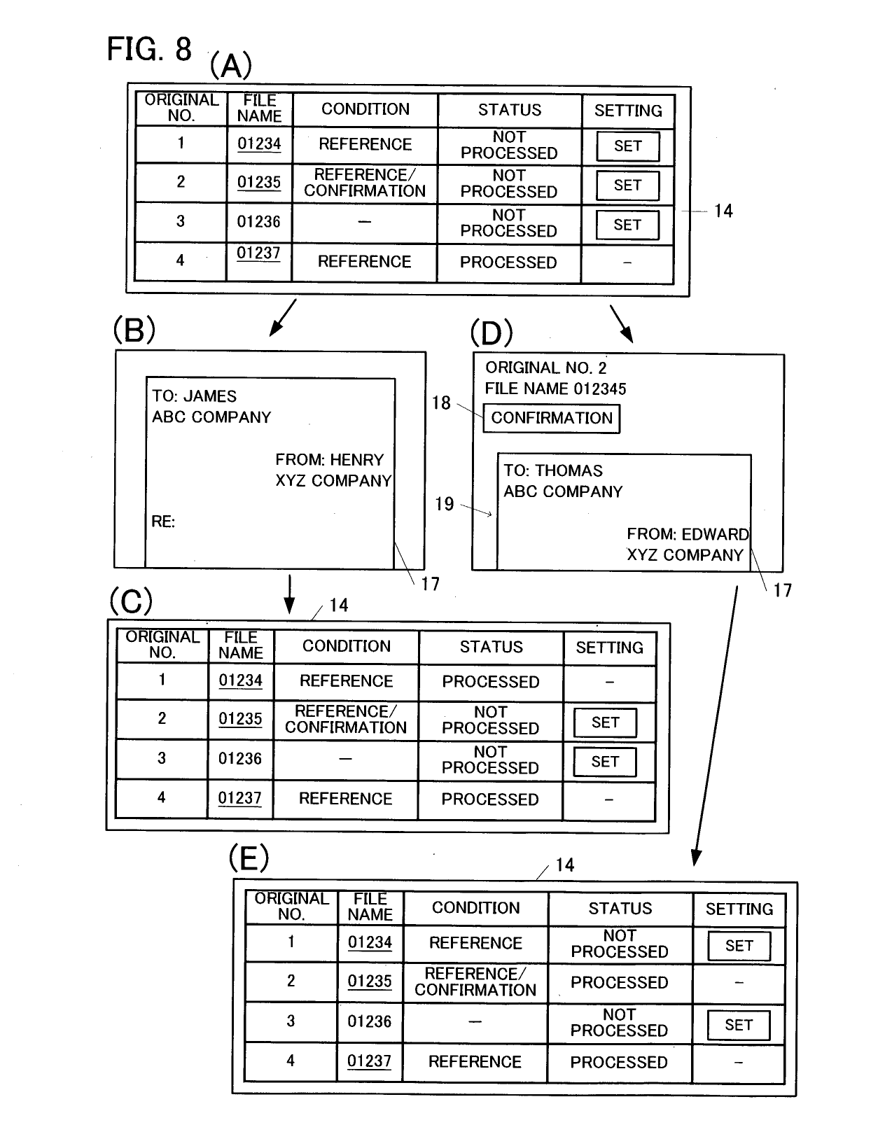

Next, an operation to be executed by the HTTP server 1 when the content managing screen 14 as shown in FIG. 8(A) is displayed on the client PC 3 and the operator or the like of the client PC 3 downloads the file (content), will be described with reference to the flowchart shown in FIG. 7. Further, the operation of the HTTP server 1 to be described with reference to FIG. 7 is also carried out in accordance with the command generated by the CPU 5 based on the control program stored in the ROM 7.

The URL of the prescribed content managing screen 14 is designated through the browser by the operator or the like of the client PC 3, and the HTTP server 1 receives the designation of the URL from the client PC 3 (S101). The HTTP server 1 transmits the content managing screen file 14A to the client PC 3 (S102). Then, the content managing screen 14 is displayed on the browser of the client PC 3.

The content managing screen 14 as shown in FIG. 8(A) is displayed at the client PC 3. Then, when the operator or the like selects the file name (in the drawing, the file name is displayed with an underline) provided with a link for downloading the file (content) to the display on the content managing screen 14, the client PC 3 requests to the HTTP server 1, the file of the URL linked to the display of the file name (for example, file name “01234”).

Then, the HTTP server 1 receives the file request (S103). The HTTP server 1 determines whether or not “reference” is stored in the “condition” column of table 13 of the file (content) corresponding to the designated URL (S104). When “reference” is stored, screen information of an original document 17 as shown in FIG. 8(B) for example is transmitted to the client PC 3 as the requested file (content) (S105).

Furthermore, “not processed” stored in the “status” column of the table 13 is changed to “processed” (S106). “Display button” stored in the “setting” column is changed to “not display button” (S107). Accompanying the change, the content managing screen file 14A is updated (S108).

As described above, after the file (content) has been referenced by any one of the client PCs 3, “processed” is set in the “status” column, and “not display button” is set in the “setting” column in the file of table 13. When the content managing screen 14 is displayed at any one of the client PCs 3 afterwards, “processed” is displayed as information indicating the fact of referenced in the “status” column of the file of the referenced content (for example, file name “01234”), and the set button 14a is not displayed. Therefore, the operator or the like of the client PC 3 can confirm from the information displayed in the “status” column of the content managing screen 14, whether or not a processing (reference) defined in the “condition” column is executed to the file (content).

Meanwhile, when it is determined that “reference” is not stored in S104, screen information of an original display screen 19 for displaying an original document 17 as the requested file (content), a “confirmation” button 18, a file name or the like as shown in FIG. 8(D) as an example is formed and transmitted to the client PC 3 (S109). Then, the screen information is displayed on the client PC 3.

A command is provided in the “confirmation” button 18. When the operator or the like of the client PC 3 selects the “confirmation” button 18, information of the fact that the selection has been made (hereinafter referred to as a confirmation information) is input to the HTTP server 1 (S110). As it has been described in S106 through S108, the HTTP server 1 changes “not processed” stored in the “status” column of table 13 to “processed”, and changes “display button” in the “setting” column to “not display button”. In addition, the HTTP server 1 updates the content managing screen file 14A. Meanwhile, in S110, when the “confirmation” button 18 is not selected, table 13 is not updated.

As described above, when “reference/confirmation” is set in the “condition” column of table 13, “not processed” in the “status” column is not changed to “processed” just by the file (content) being referenced. When the “confirmation” button 18 is selected, “not processed” in the “status” column is changed to “processed” for a first time. By fixing an agreement for when selecting the “confirmation” button 18 at the client PC 3 between the users, the agreement can be used for conveying the intention of the person who referenced the original document to a person who uploaded the original document.

The agreement between the users of the HTTP server 1 can be as follows. For example, in the case of just referencing the file (content) at the client PC 3, the original display screen 19 is displayed, and the screen 19 is ended without selecting the “confirmation” button 18. Only when indicating the intention of a fact that the detail of the original document has been confirmed, the “confirmation” button 18 is selected from the original display screen 19. If such an agreement is made, the person who uploaded the original document to the HTTP server 1 can grasp a fact that the detail of the original document has been confirmed after the original document has been read, not just that the original document has been referenced.

Further, the input of the confirmation information of S110 is not limited to an operation carried out by the “confirmation” button 18 in the original display screen 19 being selected. Instead, for example, the input can be impressing of a so-called digital seal, or inputting of the ID and the password. By adopting such inputting methods, a person who can input the confirmation information can be limited to specific persons.

When adopting the digital seal impressing, an impressing space for the digital seal is formed in place of the “confirmation” button 18 in the original display screen 19. When the operator or the like of the client PC 3 impresses the digital seal by a prescribed operation, it is determined “YES” in S110, and the processing of S106 through S108 are executed. Moreover, when adopting the input of the ID and the password, for example, an input space for the ID and the password is formed in place of the “confirmation” button 18 in the original display screen 19. Then, only when the ID and the password that are registered in the HTTP server 1 in advance are input, it is determined “YES” in S110, and the processing of S106 through S108 are executed.

Further, even when the “status” column of the table 13 for each file is “processed”, a person who uploaded the original document to the HTTP server 1 cannot confirm unless the content managing screen 14 is displayed on the browser of the client PC 3. Therefore, to carry out the notification of “processed” more rapidly, the HTTP server 1 can be provided with a G3 or G4 facsimile function, and an electronic mail transmission function. Then, when “not processed” in the “status” column of table 13 is changed to “processed”, a notification of such a fact can be transmitted in the form of an electronic mail or a facsimile to the client PC 3 that uploaded the file.

Moreover, the storing of the content to the RAM 3 in the HTTP server 1 is carried out by uploading the content from the client PC 3. However, when the HTTP server 1 is included in a facsimile server or the like (not shown in the drawings) and used, the storing is not limited to uploading, and the image data or the like that is obtained by other communication methods can be stored. For example, in the facsimile server or the like that includes the HTTP server 1, a prescribed data processing corresponding to the HTTP protocol can be executed to the image data received by the G3 or G4 facsimile or the Internet facsimile, or the image data scanned by a scanning unit of the facsimile server or the like. Then, the image data can be stored to the RAM 3.

What is claimed is:

1. A Hyper Text Transfer Protocol (HTTP) server comprising:
means for storing processing status identification information which identifies a condition for changing a status for content by assigning a corresponding file name to each content; and
means for transmitting the file name of the content stored in the means for storing and the processing status identification information in accordance with a request from a HTTP client.

2. The HTTP server according to claim 1, wherein the condition for changing the status of the content is a reference of the content by the HTTP client.

3. The HTTP server according to claim 1, wherein the condition for changing the status of the content is a reference of the content and a specific input for the content by the HTTP client.

4. The HTTP server according to claim 1, further comprising means for setting the condition for changing the status of the content, wherein the means for transmitting transmits after the condition for changing the status of the content is set by the means for setting.

5. The HTTP server according to claim 1, further comprising means for setting the condition for changing the status of the content, wherein the means for transmitting applies a link to the file name for downloading the content, and transmits after the condition for changing the status of the content is set by the means for setting.

6. The HTTP server according to claim 1, further comprising:
means for changing the processing status identification information from a not processed status to a processed status in accordance with a request from the HTTP client; and
means for notifying that the processing status identification information has been changed to the processed status by the means for changing.

7. A Hyper Text Transfer Protocol (HTTP) server comprising:
means for storing a plurality of HTTP contents;
means for storing a processing status identification information for identifying whether each of the contents is processed or not processed for each of the contents; and
means for transmitting the processing status identification information for each of the contents by a request from the HTTP client.

8. The HTTP server according to claim 7, wherein the processing is a reference of the contents by the HTTP client.

9. The HTTP server according to claim 7, wherein the processing is a reference of the contents and a specific input for the contents by the HTTP client.

10. The HTTP server according to claim 7, further comprising means for setting a processing for each of the content, wherein the means for transmitting transmits after the processing is set by the means for setting.

11. The HTTP server according to claim 7, further comprising means for setting a processing for each of the contents, wherein the means for transmitting transmits a link for downloading the contents after the processing is set by the means for setting.

12. The HTTP server according to claim 7, further comprising:
means for changing the processing status identification information from a not processed status to be a processed status in accordance with a request from the HTTP client; and
means for notifying that the processing status identification information has been changed to the processed status by the means for changing.

13. The HTTP server according to claim 7, further comprising means for storing the HTTP contents uploaded from a client.

14. The HTTP server according to claim 7, further comprising:
a facsimile; and
means for storing an image data received by the facsimile as the HTTP contents.

15. The HTTP server according to claim 7, further comprising means for notifying that a processing for each of the contents is not set.

16. A recording medium recording a program for a computer to function as a Hyper Text Transfer Protocol (HTTP) server, comprising:
a command for storing a plurality of HTTP contents;
a command for storing a processing status identification information for identifying whether each of the contents is processed or not processed for each of the contents; and
a command for transmitting the processing status identification information for each of the contents in accordance with a request from a HTTP client.

17. The recording medium recording a program according to claim 16, further comprising a command for setting a processing for each of the contents, wherein the transmission is carried out after the processing is set.

18. The recording medium recording a program according to claim 16, further comprising a command for setting a processing for each of the contents, wherein the transmission is a transmission of a link for downloading the contents after the processing is set by the command for setting a processing.

19. The recording medium recording a program according to claim 16, further comprising:
a command for changing the processing status identification information from the not processed status to the processed status in accordance with a request from the HTTP client; and
a command for notifying that the processing status identification information has been changed to processed status by the command.

20. The recording medium recording a program according to claim 16, further comprising a command for notifying that the processing for each of contents is not set.

21. A Hyper Text Transfer Protocol (HTTP) server comprising:
a storage device that stores processing status identification information which identifies a condition for changing a status for content by assigning a corresponding file name to each content; and
a transmitter that transmits the file name of the content stored in the storage device and processing status identification information in accordance with a request from a HTTP client.
